(19) United States
(12) Patent Application Publication
(10) Pub. No.: US 2010/0083083 A1
(43) Pub. Date: Apr. 1, 2010

(54) Compressed table format

(75) Inventor: Peter Glen Berger, Irwin, PA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 12/286,681

(22) Filed: Sep. 30, 2008

(51) Int. Cl. G06F 17/21

(52) U.S. Cl. 715/212

(57) ABSTRACT

In some embodiments, the cell content portion of a table definition of a table of cells is specified in a prescribed order such that cell positions do not have to be explicitly specified with cell definitions in the cell content portion of the table definition. The cells of the table to which one or more entries in the cell content portion correspond to are inferred from the prescribed order in which the entries are specified.

### BACKGROUND OF THE INVENTION

In existing spreadsheet applications, the definition of a grid or table of cells comprises a series of definitions of the cells of the table. Typically, each cell is identified in the definition by its position in the grid or table. FIG. 1 illustrates a prior art example of the data structure of the cell content portion of a table definition. As depicted, each cell is identified by its row and column position. In some cases, only cells that include content are included in the definition.

### BRIEF DESCRIPTION OF THE DRAWINGS

Various embodiments of the invention are disclosed in the following detailed description and the accompanying drawings.

FIG. 1 illustrates a prior art example of the data structure of the cell content portion of a table definition.

FIG. 2A illustrates an embodiment of a table.

FIG. 2B illustrates an embodiment of a data structure of a cell content portion of a table definition.

FIG. 3A illustrates an embodiment of a table.

FIG. 3B illustrates an embodiment of a data structure of a cell content portion of a table definition.

FIG. 4A illustrates an embodiment of a process for specifying the cell content portion of a table definition.

FIG. 4B illustrates an embodiment of a process for rendering the content of cells of a table.

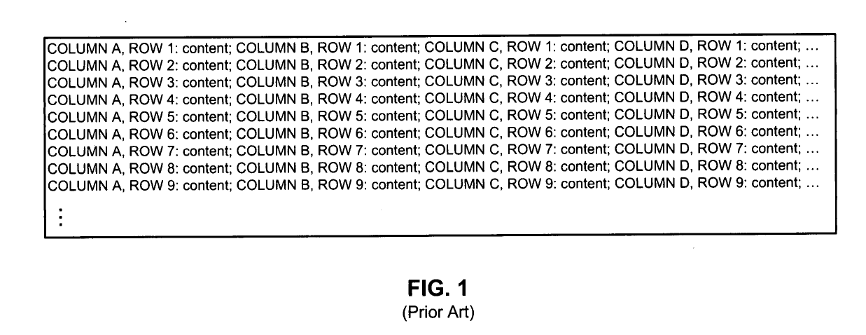

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A grid or table may include one or more rows and columns of cells. In some embodiments, the cells of a table are associated with at least standard spreadsheet functionality. The term “at least standard spreadsheet functionality” in the context of cells of a table includes the ability to define the content of one cell in such a way that the content of the one cell is determined based at least in part on the content of one or more other cells, and the content of the one cell is updated automatically without further human action if the content of one or more of the one or more other cells is changed. In some embodiments, cells in a spreadsheet application are organized into one or more individual tables or table objects, each of which includes a desired number of rows and columns of cells. In such cases, a sheet or canvas of a spreadsheet document may include a desired number of table objects as well as any desired number of other objects such as charts, graphs, images, etc. In some embodiments, a table is defined in XML (Extensible Markup Language).

Although in some of the examples described herein the cells of a spreadsheet application are organized into table objects, the techniques described herein may be similarly employed with respect to other cell configurations or organizations, such as the (seemingly) infinite single grid or table of cells in each sheet of some typical spreadsheet applications that includes an unlimited (or very large) number of rows and columns of cells. Although many of the examples provided herein are with respect to a spreadsheet application, the techniques described herein may be similarly employed with respect to any application, spreadsheet or otherwise.

As disclosed herein, in some embodiments, a cell definition included in a table definition does not include a position attribute that specifies the position of the associated cell in the table, for example, in row and column form. In some embodiments, the cell definitions in a table definition are specified in a prescribed order so that the position of an associated cell does not have to be explicitly specified with each cell definition, allowing the cell content portion of the table definition to be specified in a more compressed format. In some embodiments, a table definition includes a specification of the dimensions of the table, i.e., the number of rows and columns in the table. When rendering a table based on cell definitions that do not include position attributes, the cells with which the specified cell definitions are associated with are inferred by the order in which the cell definitions are specified and knowledge of the dimensions of the table. For example, in some embodiments, cells of a table are defined in a cell content portion of a table definition from left-to-right and from top-to-bottom.

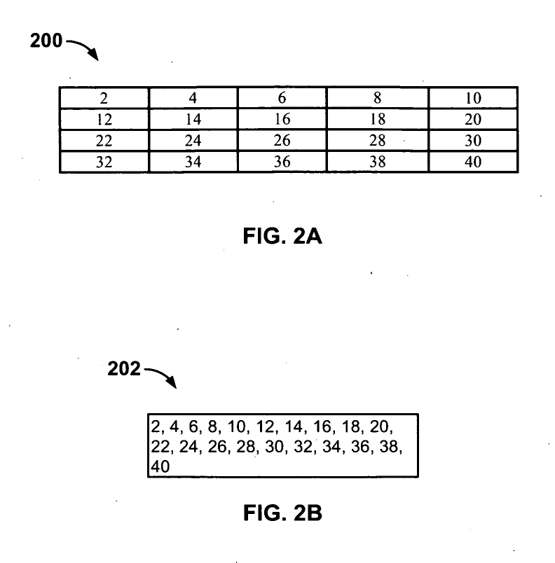

FIG. 2A illustrates an embodiment of a table 200. FIG. 2B illustrates an embodiment of a data structure 202 of a cell content portion of a table definition of table 200. As depicted, the order of the entries in data structure 202 corresponds to cells ordered from left-to-right and top-to-bottom in table 200. When the cells of table 200 are rendered based on the cell definitions in data structure 202, knowledge of the dimensions of the table (which may be separately stored in and obtained from the table definition) and/or order in which the cell definitions are specified (e.g., left-to-right and top-to-bottom) is employed to populate the cells of the table with associated content.

Table 200 of FIG. 2A comprises a fully populated table. In various embodiments, a table may include one or more blank or empty cells. In some embodiments, one or more empty cells are specified in the cell content portion of a table definition using a skip count that specifies a number of consecutive empty cells with respect to the prescribed order in which the cell content portion is specified and/or parsed. A skip count specifies the number of cells to skip from a current position or cell in the table before applying the next specified cell definition to an associated cell. A skip count format for representing empty cells allows a range of empty cells to be compactly specified with a single entry in the cell content portion of the table definition.

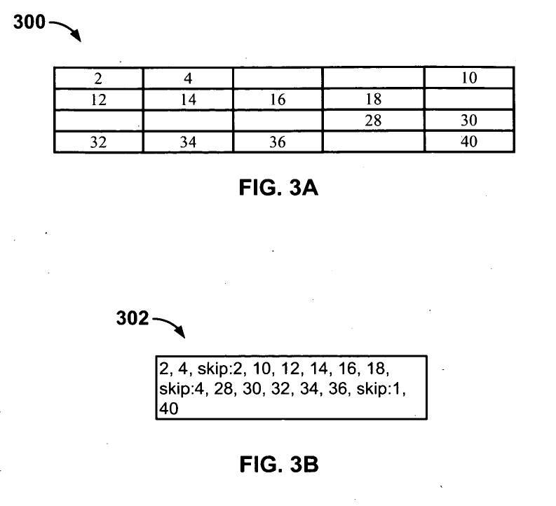

FIG. 3A illustrates an embodiment of a table 300 that includes empty cells. FIG. 3B illustrates an embodiment of a data structure 302 of a cell content portion of a table definition of table 300. As depicted, the order of the entries in data structure 302 corresponds to cells ordered from left-to-right and top-to-bottom in table 300, with empty cells being represented by skip counts (e.g., in the format skip:# in the given example). When the cells of table 300 are rendered based on the cell definitions and skip counts in data structure 302, knowledge of the dimensions of the table (which may be separately stored in and obtained from the table definition) and/or order in which the entries of the cell content portion of the table definition are specified (e.g., corresponding to cells from left-to-right and top-to-bottom in the table) is employed to populate the cells of the table with associated content.

For simplicity, only cell data values are included in the cell definitions in data structure 202 of FIG. 2B and 302 of FIG. 3B. In various embodiments, a cell definition may include specifications of any content associated with the corresponding cell. For example, a cell definition may include one or more data values and/or one or more attributes that define the formatting and/or style of the data values and/or the cell. In various embodiments, a cell data value may comprise a concrete data value that is specified in the table definition and rendered with respect to the cell and/or a pointer to an abstract or external data value, e.g., stored in an external data source from which it is retrieved when the table is rendered. Examples of data values include text, numbers, formulas, etc. Examples of formatting and/or style attributes that may be part of a cell definition include background fill color, fill pattern, fill pattern color, font style and/or size, alignment, cell border style, etc. In some embodiments, the gridlines of a table (i.e., cell borders) are defined in a separate portion of the table definition and are not included with individual cell definitions. In some embodiments, one or more formatting and/or style attributes included in a cell definition comprise references to pre-defined formats or styles in associated style sheets.

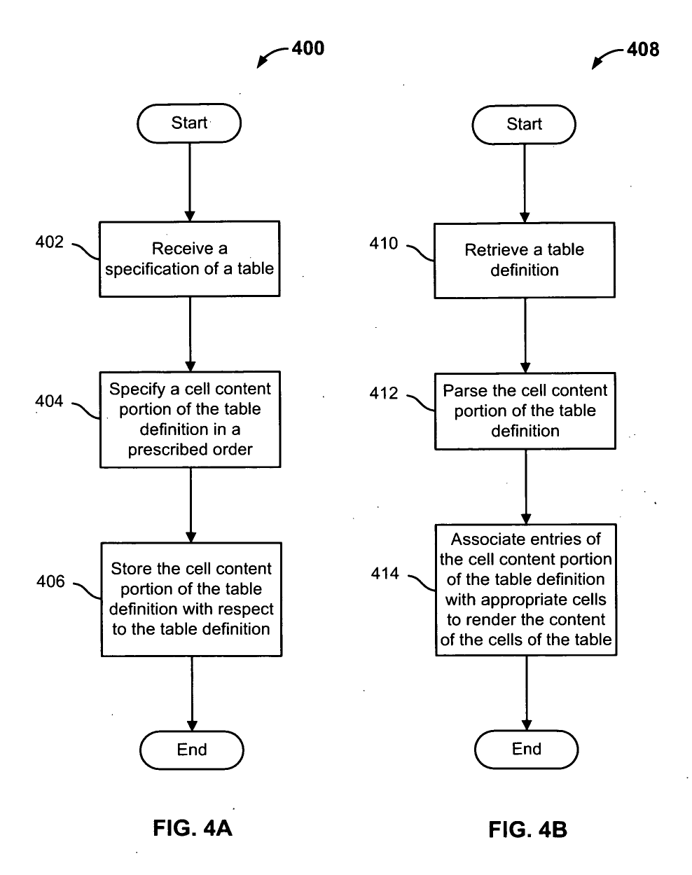

FIG. 4A illustrates an embodiment of a process for specifying the cell content portion of a table definition. For example, process 400 may be employed to specify data structure 202 of FIG. 2B and data structure 302 of FIG. 3B. Process 400 starts at 402 at which a specification of a table is received. In various embodiments, the table specification of 402 comprises a runtime event such as, for example, a user entering cell data via an application user interface or selecting an option to save such data. At 404, the cell content portion of a table definition of the table is defined or specified in a prescribed order. In some embodiments, a table definition comprises formatted data that can be stored and retrieved and interpreted to render an associated table, e.g., the table for which the specification was received at 402. In some embodiments, the order of the entries in the cell content portion of the table definition corresponds to the order of cells from left-to-right and top-to-bottom in the table. In some embodiments, the cell content portion includes cell definitions for populated cells and skip counts for empty cells. In some embodiments, the cell definitions do not include specifications of cell positions, and cell positions are inferred from the prescribed order in which cells are specified in the cell content portion of the table definition. At 406, the cell content portion of the table definition is stored with respect to the table definition. In various embodiments, a table definition may include one or more other parts, such as a grid definition portion. In some embodiments, a table definition includes a specification of the number of rows and columns in the table.

FIG. 4B illustrates an embodiment of a process for rendering the content of cells of a table. In some embodiments, process 408 is employed to render the cell content portion defined and stored using process 400. For example, process 408 may be employed to render the cell content portions of table 200 of FIG. 2A and table 300 of FIG. 3A. At 410, a table definition is retrieved. For example, the table definition may be retrieved in response to a request for the table or a sheet or document in which the table is included. In some embodiment, 410 includes retrieving table dimensions (i.e., the number of rows and columns in the table) from the table definition. At 412, a cell content portion of the table definition is parsed. In some embodiments, the cell content portion is parsed in a prescribed order that corresponds to cells from left-to-right and top-to-bottom in the table. At 414, entries included in the cell content portion are associated with the appropriate cells to render the content of the cells of the table. In some embodiments, the order of the entries in the cell content portion and/or knowledge of the geometry (i.e., dimensions) of the table are employed to associate cell definitions specified in the cell content portion with corresponding cells.

Specifying the cell definitions in a table definition in a prescribed order and employing skip counts to indicate empty cells instead of specifying a position attribute with respect to each cell definition allows the cell content portion of a table definition to be more compactly expressed. A more compressed table definition may be desirable to improve performance, e.g., so that an associated file can be stored and retrieved more quickly. In some embodiments, the described techniques are employed with respect to table definitions expressed in XML.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A computer program product for defining a table, the computer program product being embodied in a computer readable storage medium and comprising computer instructions for:
specifying a cell content portion of a table definition of a table of cells in a prescribed order;
wherein a cell position is not explicitly specified with a cell definition in the cell content portion of the table definition and wherein cells of the table to which one or more entries in the cell content portion correspond to are inferred from the prescribed order in which the entries are specified.

2. The computer program product recited in claim 1, wherein the prescribed order represents cells from left-to-right and top-to-bottom in the table.

3. The computer program product recited in claim 1, wherein the cell content portion includes cell definitions for populated cells.

4. The computer program product recited in claim 3, wherein a cell definition includes one or more of: one or more data values, one or more formatting attributes, and one or more style attributes.

5. The computer program product recited in claim 1, wherein the cell content portion includes one or more skip count specifications for empty cells.

6. The computer program product recited in claim 5, wherein a skip count specifies a number of consecutive empty cells.

7. The computer program product recited in claim 1, wherein the table definition comprises formatted data that can be stored and retrieved and interpreted to render the table.

8. The computer program product recited in claim 1, further comprising computer instructions for receiving a request for the table and parsing the cell content portion of the table definition to render the content of the cells of the table.

9. The computer program product recited in claim 1, wherein the table is associated with spreadsheet functionality.

10. The computer program product recited in claim 1, wherein the table definition is expressed in Extensible Markup Language (XML).

11. A system for defining a table, comprising:
a processor configured to:
specify a cell content portion of a table definition of a table of cells in a prescribed order, wherein a cell position is not explicitly specified with a cell definition in the cell content portion of the table definition and wherein cells of the table to which one or more entries in the cell content portion correspond to are inferred from the prescribed order in which the entries are specified; and
a memory coupled to the processor and configured to provide the processor with instructions.

12. The system recited in claim 11, wherein the prescribed order represents cells from left-to-right and top-to-bottom in the table.

13. The system recited in claim 11, wherein the cell content portion includes cell definitions for populated cells.

14. The system recited in claim 11, wherein the cell content portion includes one or more skip count specifications for empty cells.

15. The system recited in claim 11, wherein the table definition comprises formatted data that can be stored and retrieved and interpreted to render the table.

16. A method for defining a table, comprising:
specifying a cell content portion of a table definition of a table of cells in a prescribed order;
wherein a cell position is not explicitly specified with a cell definition in the cell content portion of the table definition and wherein cells of the table to which one or more entries in the cell content portion correspond to are inferred from the prescribed order in which the entries are specified.

17. The method recited in claim 16, wherein the prescribed order represents cells from left-to-right and top-to-bottom in the table.

18. The method recited in claim 16, wherein the cell content portion includes cell definitions for populated cells.

19. The method recited in claim 16, wherein the cell content portion includes one or more skip count specifications for empty cells.

20. The method recited in claim 16, wherein the table definition comprises formatted data that can be stored and retrieved and interpreted to render the table.
